(19) United States
(12) Patent Application Publication
(10) Pub. No.: US 2010/0149052 A1
(43) Pub. Date: Jun. 17, 2010

(54) Antenna device and radio apparatus

(75) Inventors: Masaki Nishio, Kanagawa-ken (JP); Yukako Tsutsumi, Kanagawa-ken (JP); Takayoshi Ito, Kanagawa-ken (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 12/654,271

(22) Filed: Dec. 15, 2009

(30) Foreign Application Priority Data
Dec. 17, 2008 (JP) 2008-320669

(51) Int. Cl. H01Q 9/00; H01Q 1/24

(52) U.S. Cl. 343/702; 343/745

(57) ABSTRACT

An antenna device includes an antenna element, a capacitor and a inductor. The antenna element has a length which is a quarter of a wavelength due to a first frequency. One end of the antenna element is connected to a feeding point. The other end of the antenna element is opened. The capacitor is arranged at a position having a distance which is equal or shorter than a half of a wavelength due to a second frequency from the other end of the antenna element. The inductor is arranged at a position having a distance which is equal or shorter than a quarter of the wavelength due to the second frequency from the other end of the antenna element.

### CROSS REFERENCE TO RELATED APPLICATIONS

This application is based upon and claims the benefit of priority from the Japanese Patent Application No. 2008-320669, filed on Dec. 17, 2008, the entire contents of which are incorporated herein by reference.

### BACKGROUND OF THE INVENTION

1. Field of the Invention

The present invention relates to an antenna device and a radio apparatus.

2. Description of the Related Art

An antenna device to realize a wireless communication using plural of frequencies is disclosed in JP-A 2007-181076 (KOKAI). In this reference, the antenna device includes a first element and a second element. One end of the first element is connected to a feeding point. One end of the second element is connected to a conductor. The second element is coupling with the first element electromagnetically.

The antenna device resonates with a first resonant frequency by using the second element. Moreover, the antenna device resonates with a second resonant frequency which is higher than the first resonant frequency by using the first and second elements.

However, it is difficult for the antenna device to vary the first and second resonant frequencies independently, because it uses both the first and second elements to resonate with the second resonant frequency.

### SUMMARY OF THE INVENTION

According to one aspect of the invention, an antenna device includes
an antenna element having a length which is a quarter of a wavelength due to a first frequency, one end of the antenna element being connected to a feeding point, other end of the antenna element being opened;
a capacitor arranged at a position having a distance which is equal or shorter than a half of a wavelength due to a second frequency from the other end of the antenna element;
an inductor arranged at a position having a distance which is equal or shorter than a quarter of the wavelength due to the second frequency from the other end of the antenna element.

According to other aspect of the invention, a radio apparatus includes
an antenna device including
   an antenna element having a length which is a quarter of a wavelength due to a first frequency, one end of the antenna element being connected to a feeding point, other end of the antenna element being opened,
   a capacitor arranged at a position having a distance which is equal or shorter than a half of a wavelength due to a second frequency from the other end of the antenna element, and
   an inductor arranged at a position having a distance which is equal or shorter than a quarter of the wavelength due to the second frequency from the other end of the antenna element;
a frequency convertor converting a radio signal received by the antenna device into an analog baseband signal;
an A/D convertor converting the analog baseband signal from the frequency convertor to a digital baseband signal; and
a digital signal processing circuit performing baseband signal processing for the digital baseband signal.

### BRIEF DESCRIPTION OF THE DRAWINGS

FIG. 1 is a block diagram showing an antenna device according to the first embodiment;

FIG. 2A is a diagram showing a first resonant mode in the antenna device;

FIG. 2B is a diagram showing a second resonant mode in the antenna device;

FIG. 2C is a diagram showing a third resonant mode in the antenna device;

FIG. 3A is a diagram showing an example of a variable capacitor and a variable inductor;

FIG. 3B is a diagram showing an example of a variable capacitor and a variable inductor;

FIG. 4 is a top view showing the variable capacitor;

FIG. 5 is a cross sectional view along a line V-V′ of FIG. 4;

FIG. 6 is a cross sectional view along a line VI-VI′ of FIG. 4;

FIG. 7 is a cross sectional view of switches Sa-Sd;

FIG. 8 is a block diagram showing an antenna device according to the second embodiment;

FIG. 9 is a block diagram showing an antenna device according to the third embodiment;

FIG. 10 is a perspective view showing an example of implementation of the antenna device;

FIG. 11 is a block diagram showing an antenna device according to the fourth embodiment;

FIG. 12 is a perspective view showing an example of implementation of the antenna device;

FIG. 13 is a figure showing a frequency performance by a simulation using the antenna device;

FIG. 14 is a block diagram showing a radio apparatus according to the fifth embodiment; and

FIG. 15 is a perspective view showing an example of implementation of the radio apparatus.

### DETAILED DESCRIPTION OF THE INVENTION

The embodiments will be explained with reference to the accompanying drawings.

### Description of the First Embodiment

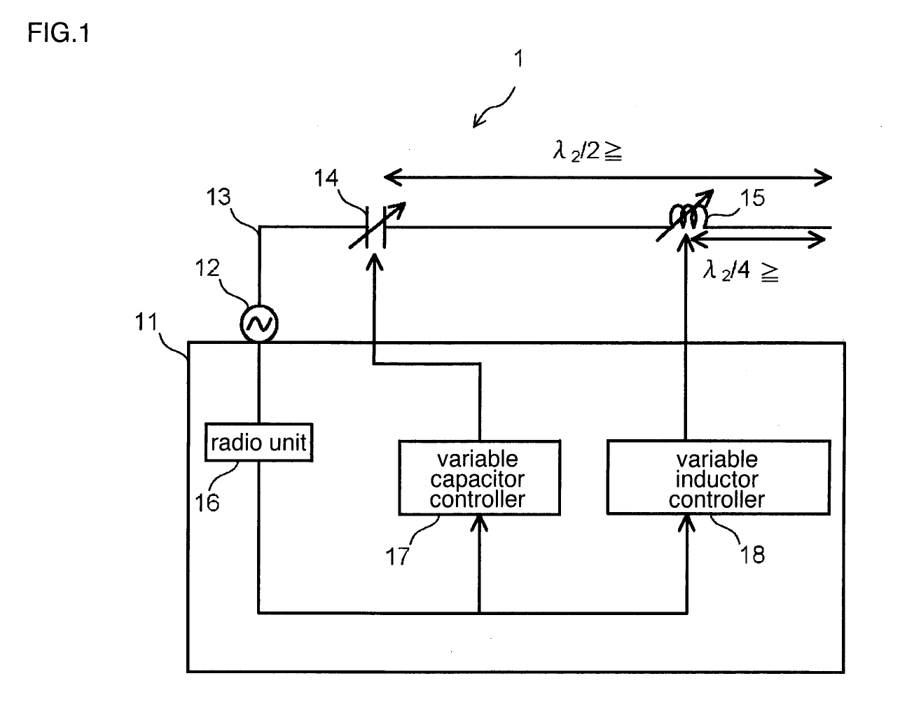

As shown in FIG. 1, an antenna device 1 includes a conductor plate 11, a feeding point 12, an antenna element 13, a variable capacitor 14 (capacitor), a variable inductor 15 (inductor), a radio unit 16, a variable capacitor controller 17 (capacitor controller), and a variable inductor controller 18 (inductor controller).

One end of the antenna element 13 is connected to the feeding point 12. The other end of the antenna element 13 is opened. Length of the antenna element 13 is a quarter of a wavelength λ1 due to a first frequency f1. The antenna element 13 has an inverted L-shaped. That is, the antenna element 13 is bent with a 90-degree. It realizes a low profile antenna. The low profile antenna is easily built in a radio apparatus, especially in a small radio apparatus using a UHF (Ultra High Frequency) band.

The variable capacitor 14 is serially arranged (loaded) at a position having a distance which is equal or shorter than a half of a wavelength λ2 due to a second frequency f2 from the other end of the antenna element 13. The variable inductor 15 is serially arranged (loaded) at a position having a distance which is equal or shorter than a quarter of the wavelength λ2 due to the second frequency f2 from the other end of the antenna element 13.

The antenna device 1 has a first resonant frequency and a second resonant frequency. The first resonant frequency is lower than the second resonant frequency. The variable capacitor controller 17 controls (varies) a capacity of the variable capacitor 14. The first resonant frequency varies by varying the capacity of the variable capacitor 14.

The variable inductor controller 18 controls (varies) an inductance of the variable inductor 15. The second resonant frequency varies by varying the inductance of the variable inductor 15.

The radio unit 16 is connected to the antenna element 13. The radio unit 16 instructs the variable capacitor controller 17 and the variable inductor controller 18 to vary the capacity of the variable capacitor 14 and the inductance of the variable inductor 15, respectively, according to a receiving condition at the antenna element 13, for example, when strength of a radio signal received at the antenna device 1 is smaller than a given threshold.

The radio unit 16 may include an identify unit which identifies a wireless communication method such as 3G. In this case, the radio unit 16 may instruct the variable capacitor controller 17 and the variable inductor controller 18 to adjust the first and second resonant frequencies to suit frequencies used in the wireless communication method.

The first frequency f1 and the second frequency f2 are following the equation (1).

f2>f1 (1)

When the frequency f1 and the second frequency f2 are following the equation (2), the antenna device 1 operates as a double resonant antenna in a frequency band from the first frequency f1 to the second frequency f2.

f1×3<f2 (2)

When the frequency f1 and the second frequency L2 are following the equation (3), the antenna device 1 operates as the double resonant antenna in a frequency band from the first frequency f1 to a frequency of three times of the first frequency f1.

f1×3>f2 (3)

The antenna device 1 can control (vary) the first and second resonant frequencies independently by varying the capacity of the variable capacitor 14 and the inductance of the variable inductor 15.

The antenna device 1 has three resonant modes which are first to third resonant modes. In the first embodiment, the antenna device 1 resonates with a basic resonant frequency in the first resonant mode. The antenna device 1 resonates with the first resonant frequency in the second resonant mode. The antenna device 1 resonates with the second resonant frequency in the third resonant mode. The first resonant frequency is higher than the basic resonant frequency. The second frequency is higher than the first frequency. Moreover, the second resonant frequency is almost equal of the second frequency f2.

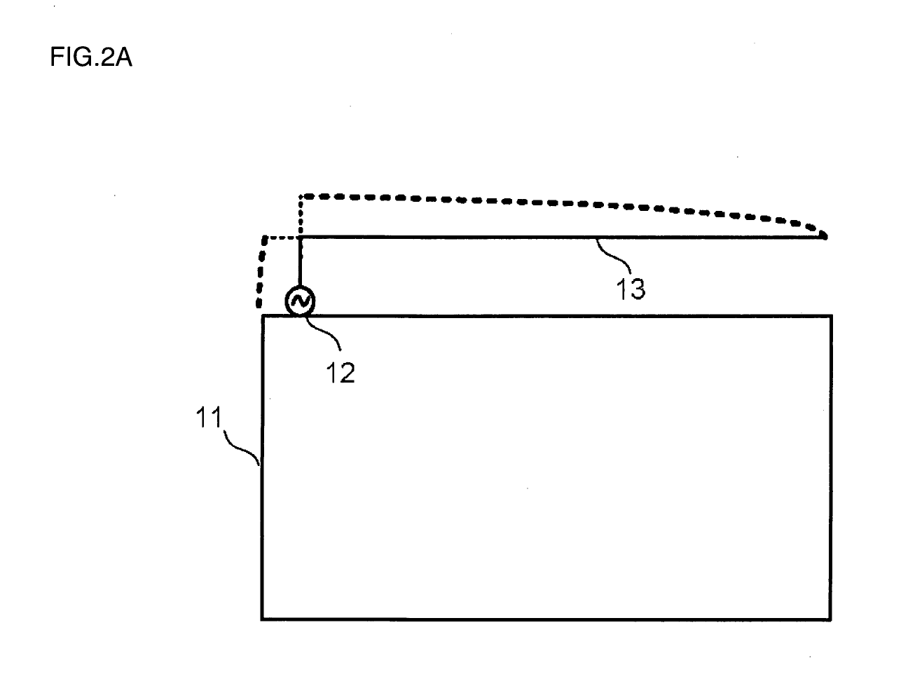

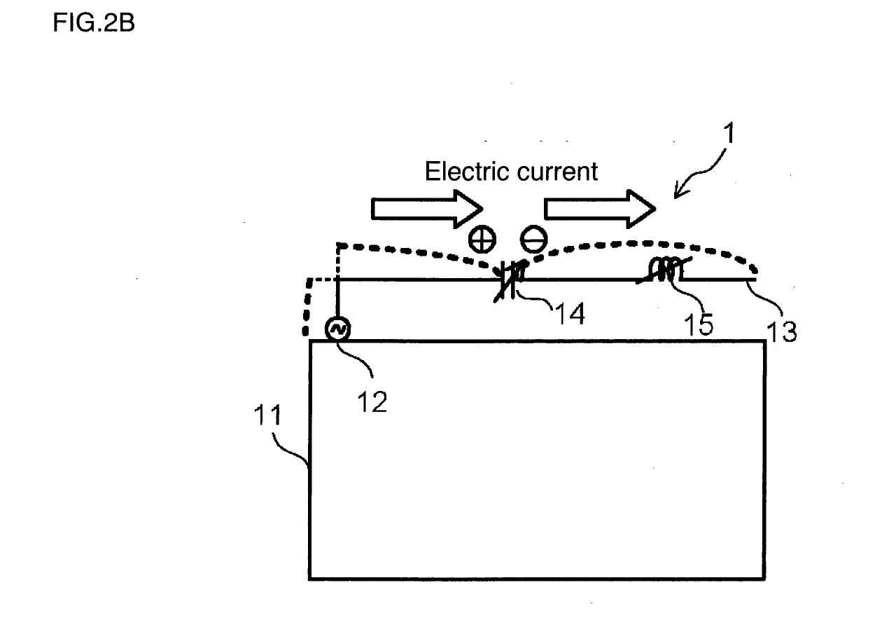

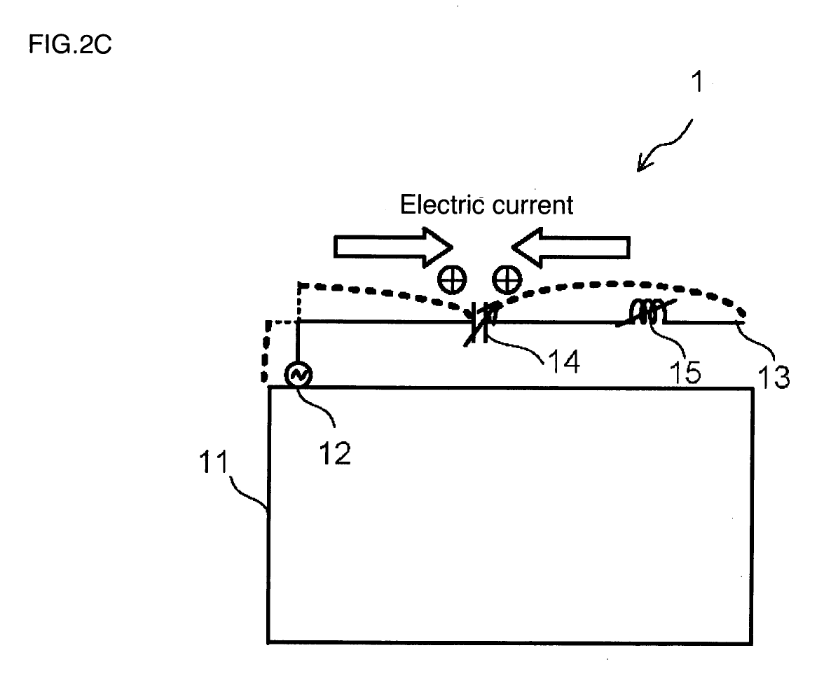

FIGS. 2A, 2B, 2C are figures explaining the first to third resonant modes, respectively. In FIG. 2A, the element 13 has an inverted L-shaped and the length of the antenna element 13 is a quarter of the wavelength λ1 due to the first frequency f1. In FIGS. 2B, 2C, the variable capacitor 14 is arranged having a distance which is a half of the wavelength λ2 due to the second frequency f2 from the other end of the antenna element 13. Dashed lines show current distribution.

Hereinafter, we will explain operation of the antenna device 1 using FIGS. 2A, 2B, 2C.

In FIG. 2A, the antenna device does not have the variable capacitor 14 and the first resonant mode is generated. When the variable capacitor 14 is loaded and the capacity of the variable capacitor 14 is 0 to several [pF (pico Farad)], the second or third resonant mode are generated as shown in FIGS. 2B,2C.

In the second resonant mode of FIG. 2B, the antenna element 13 is divided into two portions. One portion is from one end of the antenna element 13 which is connected to the feeding point 12 to the variable capacitor 14. Other portion is from the variable capacitor 14 to the other end of the antenna element 13 which is opened. Since the electrons are beat with a same direction in both portions, the voltage difference between the both ends of the variable capacitor 14 is large. As a result, the first resonant frequency of the second resonant mode varies with varying the capacity of the variable capacitor 14.

The first resonant frequency of the second resonant mode becomes lower with increasing the capacity of the variable capacitor 14 to be several [pF]. The second resonant mode transits to the first resonant mode with becoming lower the first resonant frequency to be close to the basic resonant frequency.

In the third resonant mode of FIG. 2C, the electrons are beat with opposite directions in the two portions. Therefore, the voltage difference between the both ends of the variable capacitor 14 is small. As a result, the second resonant frequency keeps being almost constant regardless of varying the capacity of the variable capacitor 14.

However, the second resonant frequency becomes to be a frequency of three times of the first frequency f1 (f1×3), when the capacity of the variable capacitor 14 becomes large.

When the second frequency f2 almost equals to (f1×3), the second resonant frequency of the third resonant mode almost equals to the basic resonant frequency of the first resonant mode which is (f1×3). Therefore, the second resonant frequency of the third resonant mode does not vary, even when the capacity of the variable capacitor 14 becomes large. As a result, the first resonant frequency of the second resonant mode can vary independently of the second resonant frequency of the third resonant mode by varying the capacity of the variable capacitor 14.

When the capacity of the variable capacitor 14 increases from 0 or several [pF] to large [pF], the first resonant frequency in a low frequency area becomes lower with keeping the second resonant mode. Therefore, the first resonant frequency varies independently of the second resonant frequency. Moreover, impedance of the variable capacitor 14 becomes smaller with increasing the capacity of the variable capacitor 14. Small impedance is almost same condition as the first resonant mode (“Through”) without the variable capacitor 14.

Moreover, the second resonant frequency in a high frequency area transits to that in a low frequency area with keeping the third resonant mode by loading the inductance of the variable inductor 15. Therefore, the second resonant frequency can vary independently of the resonant modes.

Next, the variable inductor 15 is loaded at a position having a distance which is a quarter of the wavelength λ2 due to the second frequency f2 from the other end of the antenna element 13. In the third resonant mode of FIG. 2C, the second resonant frequency depends on the variable inductor 15. That is, the second resonant frequency of the third resonant mode varies by varying the inductance of the variable inductor 15.

The second resonant mode transits to the first resonant mode which is not affected due to the inductance by increasing the capacity of the variable capacitor 14. The first resonant frequency of the second resonant mode keeps almost being constant regardless of the inductance of the variable inductor 15. Therefore, the second resonant frequency of the third resonant mode varies independently of the first resonant frequency by varying the inductance of the variable inductor 15.

Hereinafter, we will describe an example of the variable capacitor 14 and the variable inductor 15.

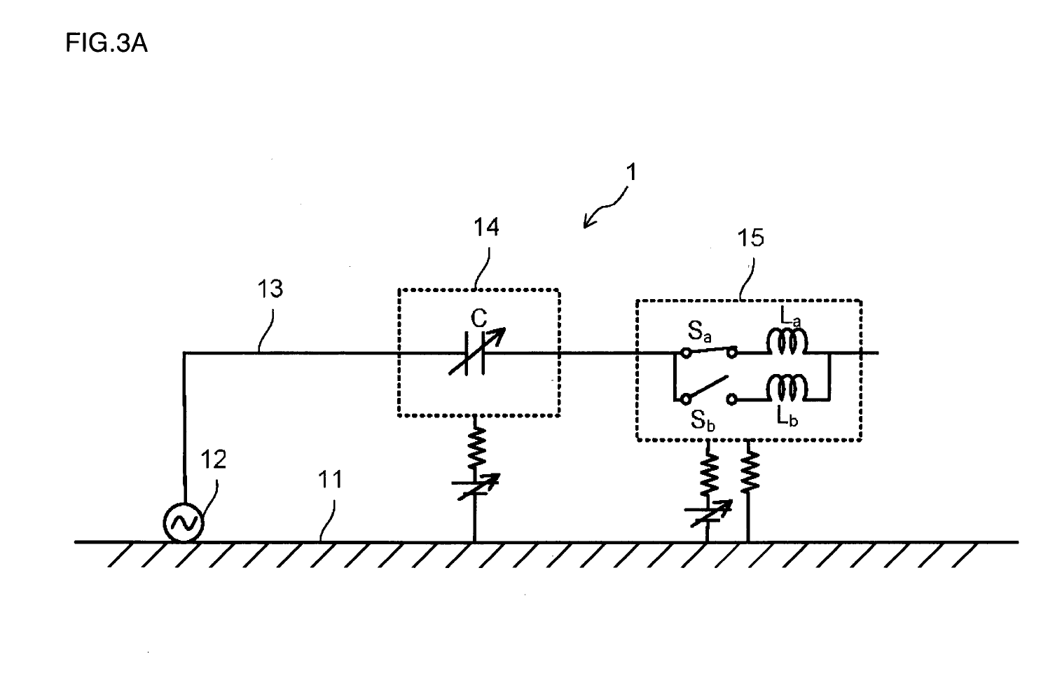

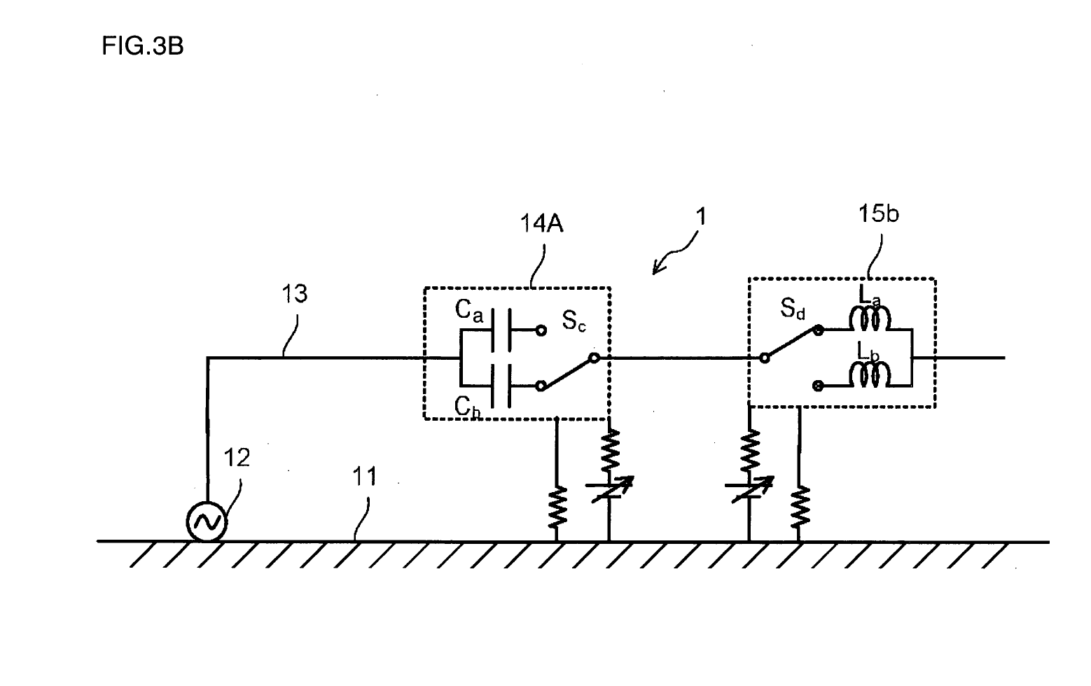

As shown in FIG. 3A, the variable capacitor 14 includes at least one variable capacitor C. When plural of variable capacitors C exist, these variable capacitors C are connected in parallel with the antenna element 13.

The variable inductor 15 includes inductances La, Lb and switches Sa, Sb. The inductances La, Lb are arranged in parallel with each other. The inductances La, Lb are connected to the antenna element 13 through the switches Sa, Sb, respectively.

As shown in FIG. 3B, the variable capacitor 14A includes capacitors Ca, Cb and switch Sc. The capacitors Ca, Cb are arranged in parallel with each other. The capacitors Ca, Cb are connected to the antenna element 13 through the switches Sc. The capacity of the capacitor Ca is a fraction [pF] and the capacity of the capacitor Cb is several [pF] to be variable capacitors.

The variable inductor 15 includes inductances La, Lb and switch Sd. The inductances La, Lb are arranged in parallel with each other. The inductances La, Lb are connected to the antenna element 13 through the switch Sd.

The variable capacitor C and the switches Sa-Sd may be formed by MEMS (Micro Electro Mechanical System).

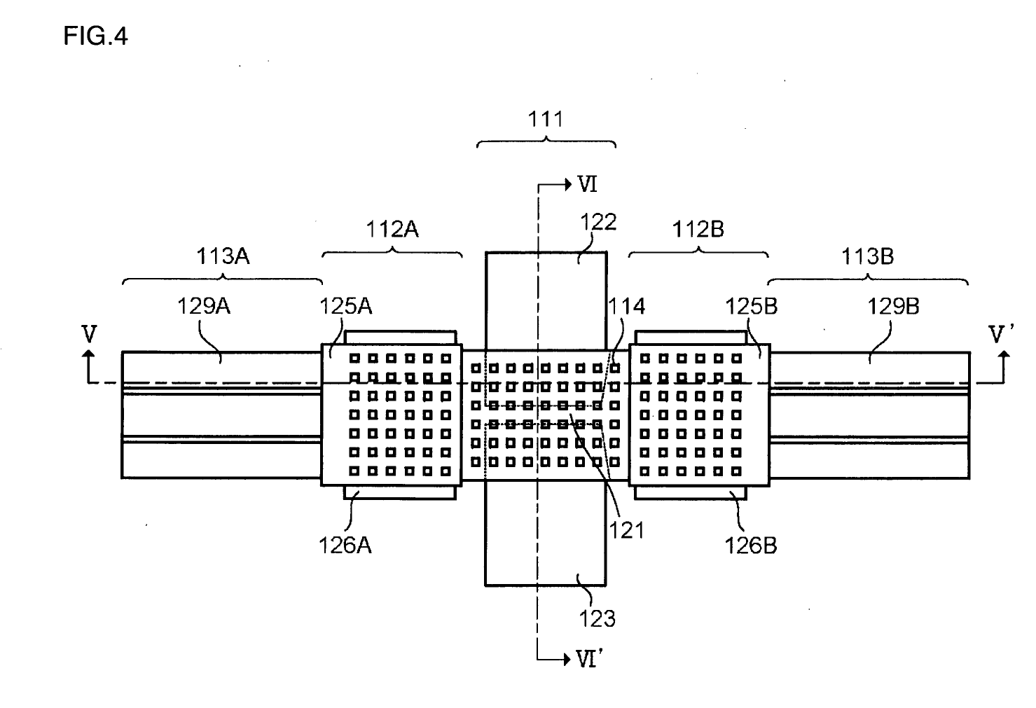

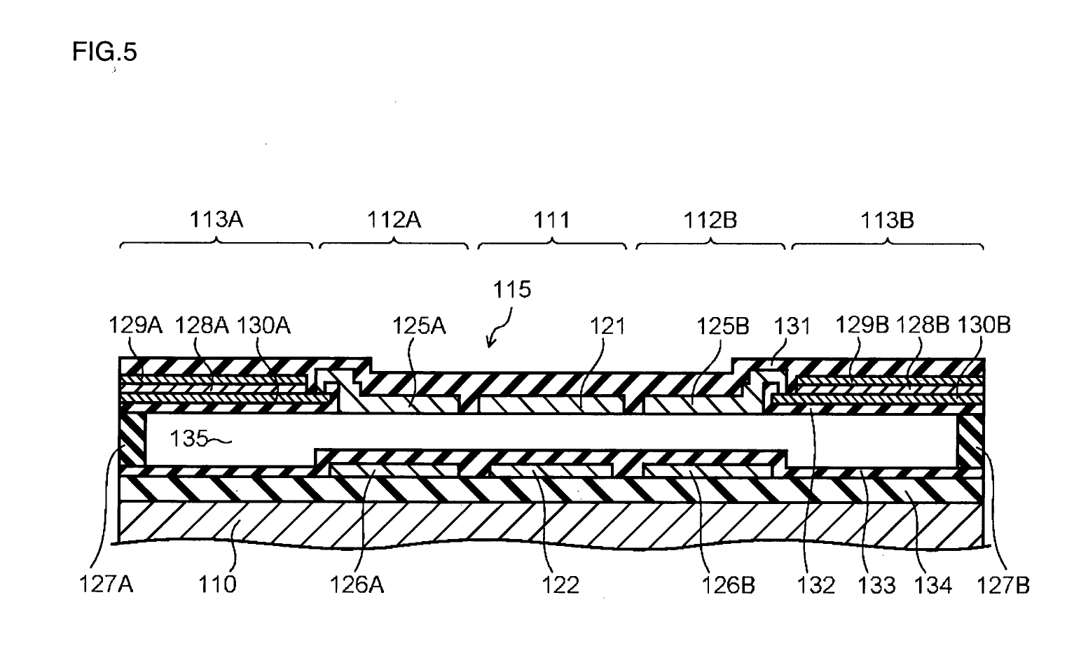

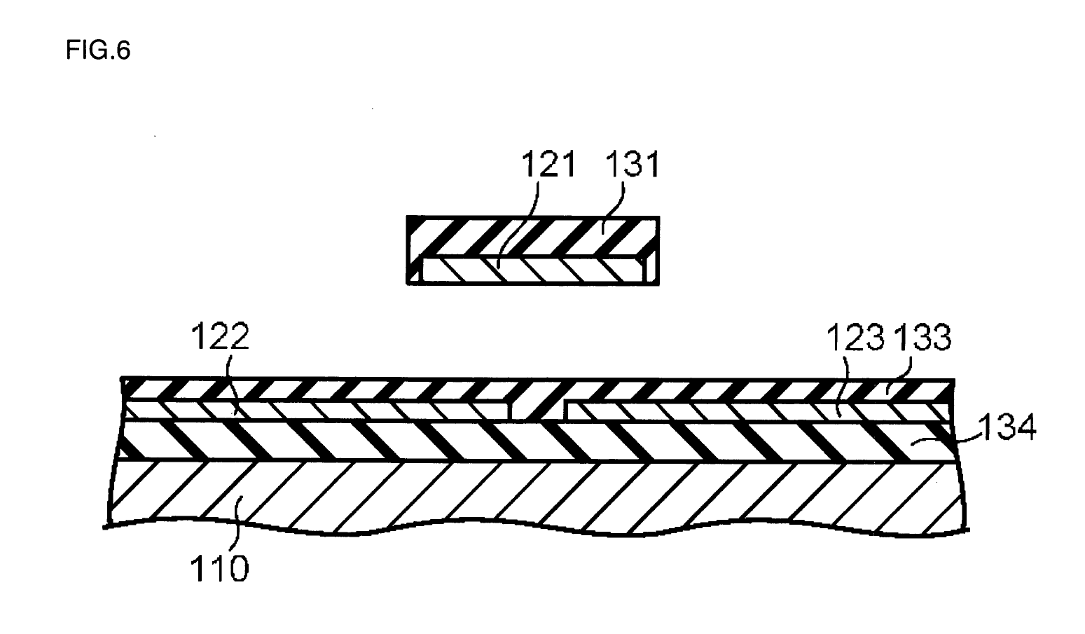

Next, an example of the variable capacitor C and the switches Sa-Sd using MEMS are described with reference to FIGS. 4-7. FIG. 4 is a top view showing the variable capacitor C. FIG. 5 is a cross sectional view along a line V-V′ of FIG. 4. FIG. 6 is a cross sectional view along a line VI-VI′ of FIG. 4.

The variable capacitor C includes a variable capacitance 111, static actuators 112A, 112B, and piezoelectric actuators 113A, 113B. The variable capacitance 111, the static actuators 112A, 112B, and the piezoelectric actuators 113A, 113B are formed in a structure including an elastic member 115 fixed on a silicon substrate 110 by anchors 127A, 127B.

The variable capacitance 111 includes an upper electrode 121 formed in the elastic member 115 and lower electrodes 122, 123 formed in the silicon substrate 110. A cavity 135 is formed between the elastic member 115 and the silicon substrate 110. Interval between the upper electrode 121 and an insulating film 133 is approximately 1.5 [μm].

The upper electrode 121 floats physically and electrically. The static actuators 112A, 112B and the piezoelectric actuators 113A, 113B drive the upper electrode 121 to vary a distance between the upper electrode 121 and the lower electrodes 122, 123. A coupling capacitance also varies between the upper electrode 121 and the lower electrodes 122, 123.

Next, a hybrid actuator is explained below. The hybrid actuator controls a distance between electrodes of the variable capacitance 111. The static actuators 112A, 112B are located at both sides of the variable capacitance 111, respectively. The static actuators 112A, 112B includes the upper electrodes 125A, 125B and the lower electrodes 126A, 126B, respectively.

The piezoelectric actuators 113A, 113B are located between the static actuators 112A, 112B and the anchors 127A, 127B, respectively. The piezoelectric actuators 113A, 113B includes piezoelectric membranes 128A, 128B, upper electrodes 129A, 129B, and lower electrodes 130A, 130B. The piezoelectric membranes 128A, 128B are inserted between the upper electrodes 129A, 129B and the lower electrodes 130A, 130B, respectively. The piezoelectric membranes 128A, 128B may be made of AlN (aluminum nitride) or PZT (lead zirconate titanate).

An insulating film 131 is formed on the upper electrodes 121, 125A, 125B, 129A, 129B. An insulating film 132 is formed under the lower electrodes 130A, 130B.

The lower electrodes 122, 123, 126A, 126B are formed on an insulating film 134.

The insulating film 134 is formed on the silicon substrate 110. The insulating film 133 is formed on the lower electrodes 122, 123, 126A, 126B.

When voltage difference is added between the upper electrodes 129A, 129B and the lower electrodes 130A, 130B, the piezoelectric membranes 128A, 128B are displaced and one end of the elastic member 115 is displaced downward. As a result, the distance between the upper electrodes 125A, 125B and the lower electrodes 126A, 126B varies.

When voltage difference is added between the upper electrodes 125A, 125B and the lower electrodes 126A, 126B, the upper electrode 121 is displaced downward. As a result, the distance between the upper electrode 121 and the lower electrodes 122, 123 varies and the capacitance also varies.

The upper electrodes 121 may be displaced upward by equalizing voltages of the piezoelectric actuators 113A, 113B after or at the same time equalizing voltages of the static actuators 112A, 112B.

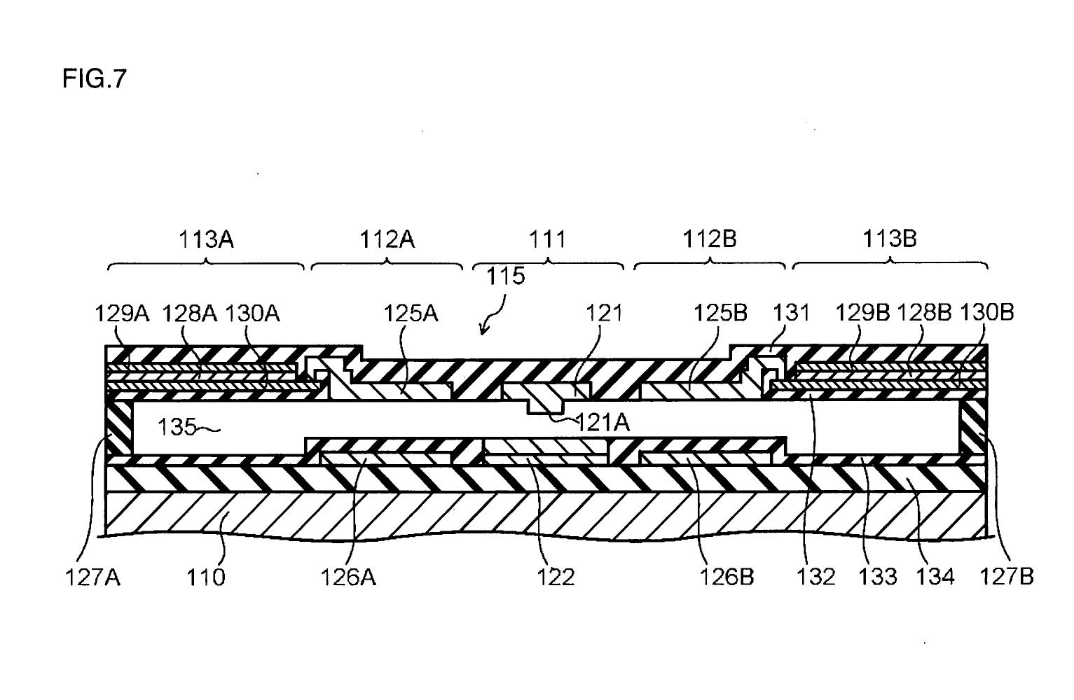

FIG. 7 is a cross sectional view of switches Sa-Sd. The switches Sa-Sd have a convex portion 121A toward the lower electrode 122. Existence of the convex portion 121A is different from the variable capacitor C. The convex portion 121A electrically touches the lower electrode 122, when the convex portion 121A is displaced downward. Other components are same as the variable capacitor C of FIGS. 4-6.

According to the first embodiment, the antenna device 1 varies the first resonant frequency which is lower independently of the second resonant frequency by varying the capacity of the variable capacitor 14.

Moreover, the antenna device 1 varies the second resonant frequency which is higher independently of the first resonant frequency by varying the inductance of the variable inductor 15.

The variable capacitor 14, and the variable capacitors C, Ca, Cb and the switches Sa-Sd in the variable inductor 15 are formed by MEMS element. The MEMS element has small loss because of using metal electrode having low resistance. Moreover, since the MEMS element has a low resonant frequency, the MEMS element may not resonate with a high-frequency signal easily. Therefore, the antenna device 1 can transmit/receive the high-frequency signal with small distortion and small loss.

### Description of the Second Embodiment

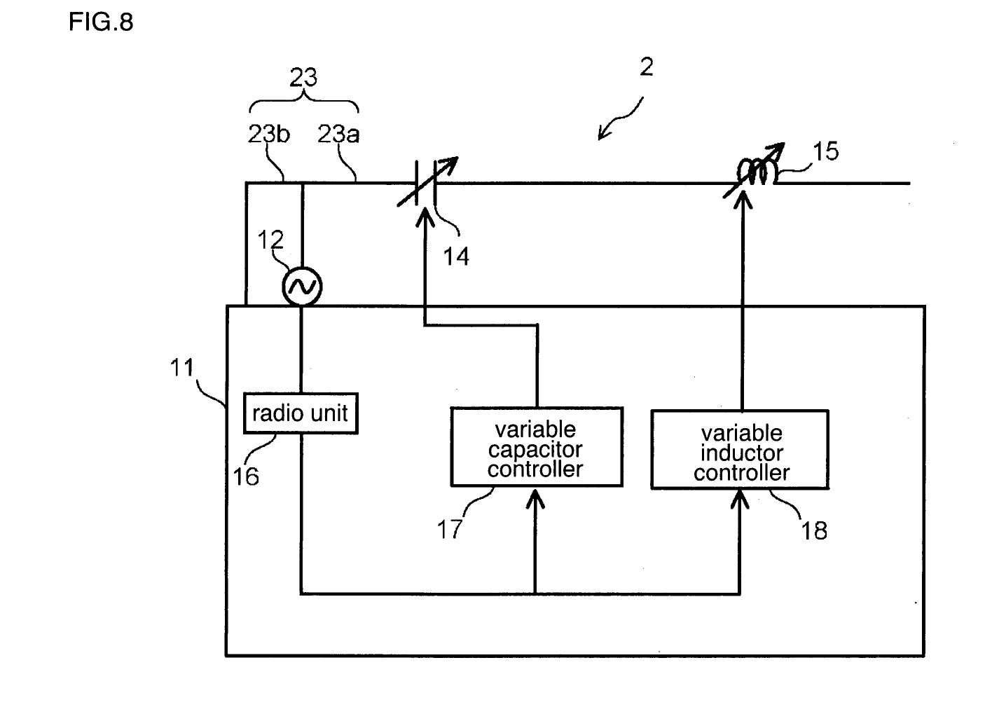

As shown in FIG. 8, an antenna device 2 of the second embodiment is almost same as the antenna device 1 of the first embodiment except that an antenna element 23 has an inverted F-shaped.

The antenna element 23 has a first element 23a (body of the antenna element 23) and a second element 23b (short-circuit element). One end of the first element 23a is connected to the feeding point 12. The other end of the first element 23a is opened. One end of the second element 23b is connected to the first element 23a. The other end of the second element is connected to the conductor plate 11 near the feeding point 12. The first element 23a is short-circuited to close of the feeding point 12 through the second element 23b.

The antenna device 2 easily realizes impedance matching of the antenna element 23 by short-circuiting the first element 23a through the second element 23b. Moreover, the antenna device 2 achieves same effects as the antenna device 1 of the first embodiment.

### Description of the Third Embodiment

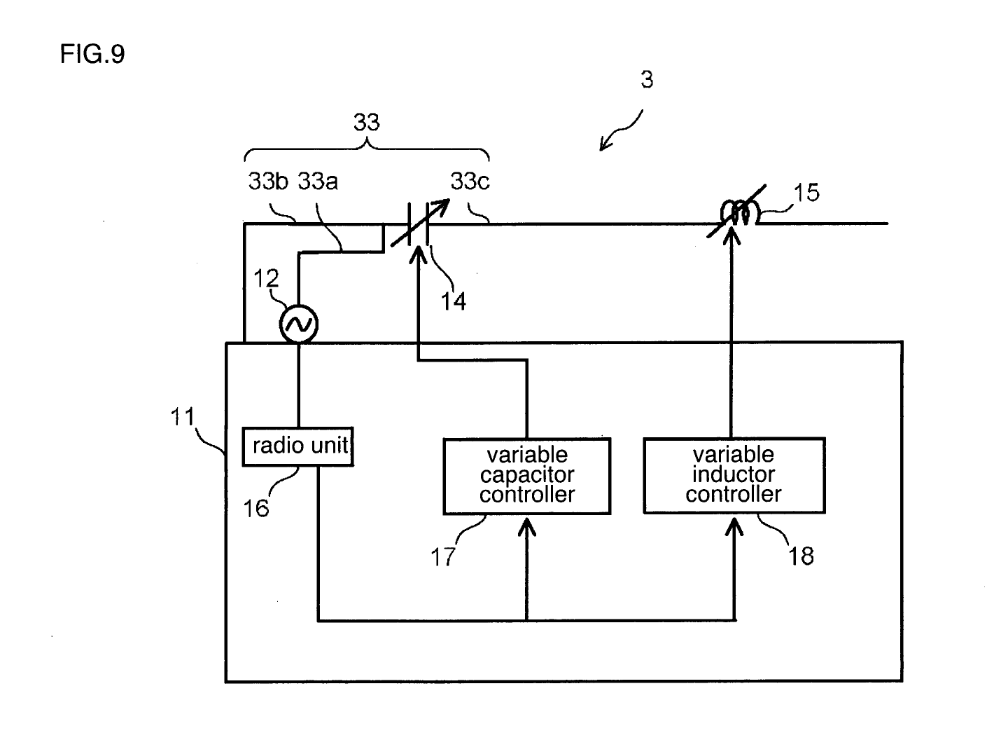

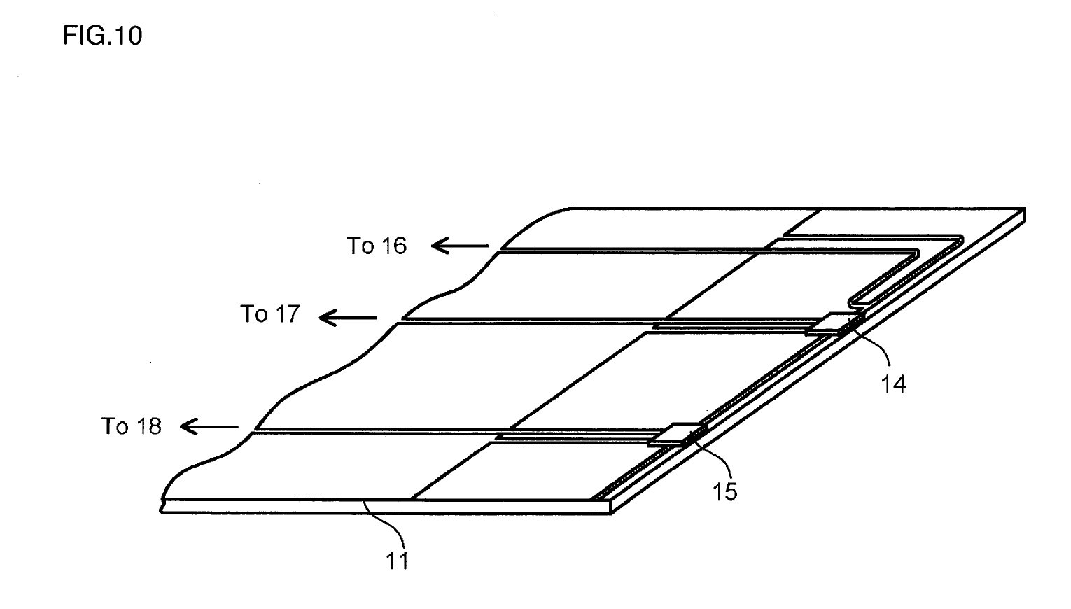

As shown in FIG. 9, an antenna device 3 of the third embodiment is almost same as the antenna device 2 of the second embodiment except that an antenna element 33 has a folding structure from the feeding point 12 to the variable capacitor 14. Also, FIG. 10 shows an example of implementation of the antenna device 3.

The antenna element 33 includes a third element 33a, a fourth element 33b, and a fifth element 33c. The third element 33a, the fourth element 33b and the fifth element 33c correspond to a first element, a second element and a third element in the claims, respectively. One end of the third element 33a is connected to the feeding point 12. The other end of the third element 33a is connected to the variable capacitor 14. One end of the fourth element 33b is connected to the conductor plate 11 near the feeding point 12. The other end of the fourth element 33b is connected to the third element 33a at a location near the other end of the third element 33a. One end of the fifth element 33c is connected to the variable capacitor 14. The other end of the fifth element 33c is opened.

The third element 33a and the fourth element 33b have equal length. The third element 33a is arranged almost parallel to the fourth element 33b.

The antenna device 3 can adjust direction and frequency band of radio wave, because the antenna device 3 has a lot of flexibility of design, for example, interval between the third element 33a and the fourth element 33b for folding. Therefore, the frequency band which is used to transmit/receive radio wave can be extended. Moreover, the antenna device 3 achieves same effects as the antenna device 1 of the first embodiment.

### Description of the Fourth Embodiment

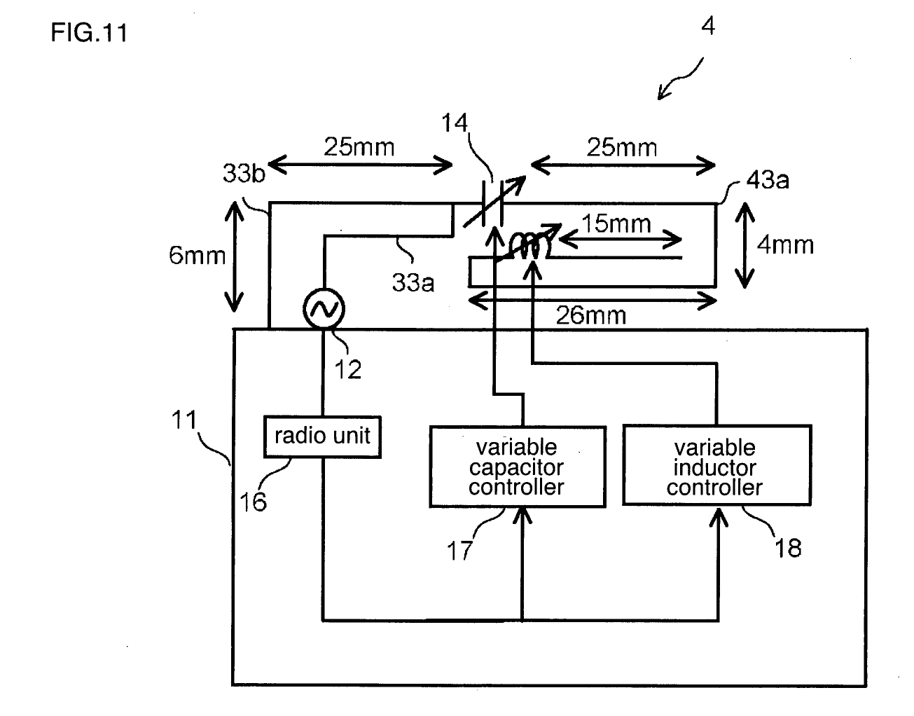

As shown in FIG. 11, an antenna device 4 of the fourth embodiment is almost same as the antenna device 3 of the third embodiment except that an antenna element has two folding structures. One folding structure includes the third element 33a and the fourth element 33b, which is from the feeding point 12 to the variable capacitor 14. The other folding structure includes a sixth element 43a, which is from the variable capacitor 14 to the opened end.

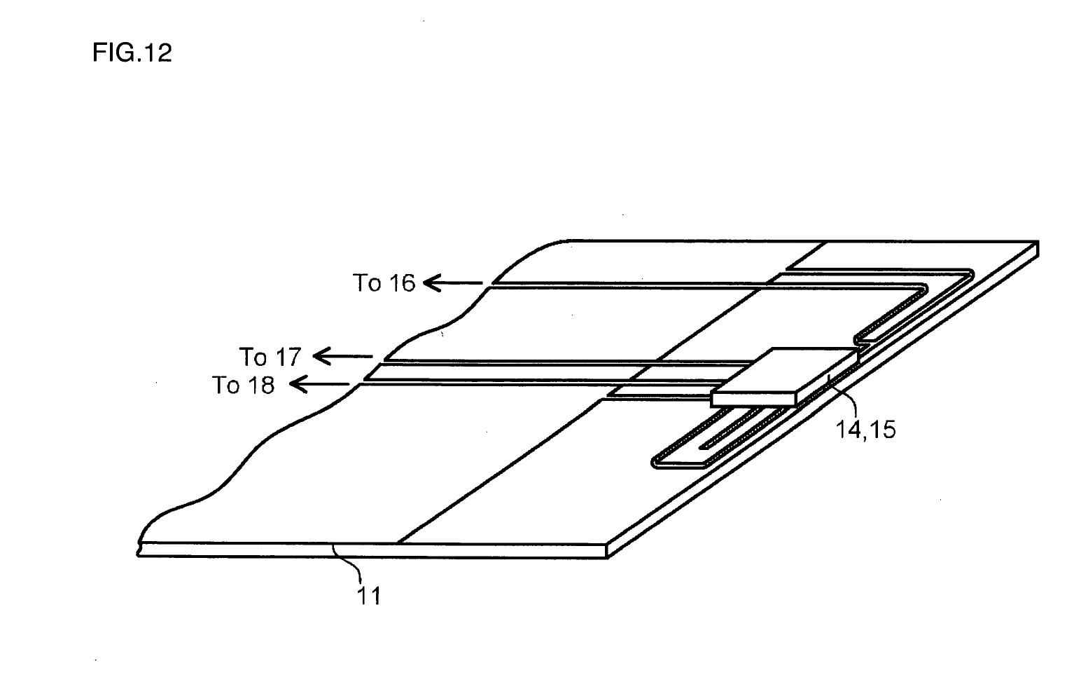

Also, FIG. 12 shows an example of implementation of the antenna device 4. In FIG. 12, the variable capacitor 14 and the variable inductor 15 are packed in a module.

The antenna device 4 is set on a substrate having a size of 111 [mm]×65 [mm]. Interval length between the feeding point 12 and the variable capacitor 14 is 6 [mm]. Interval length between the third element 33a and the fourth element 33b is 3 [mm].

Length of the sixth element 43a from the variable capacitor 14 to the opened end is 76 [mm]. Length from the opened end to the variable inductor 15 is 15 [mm].

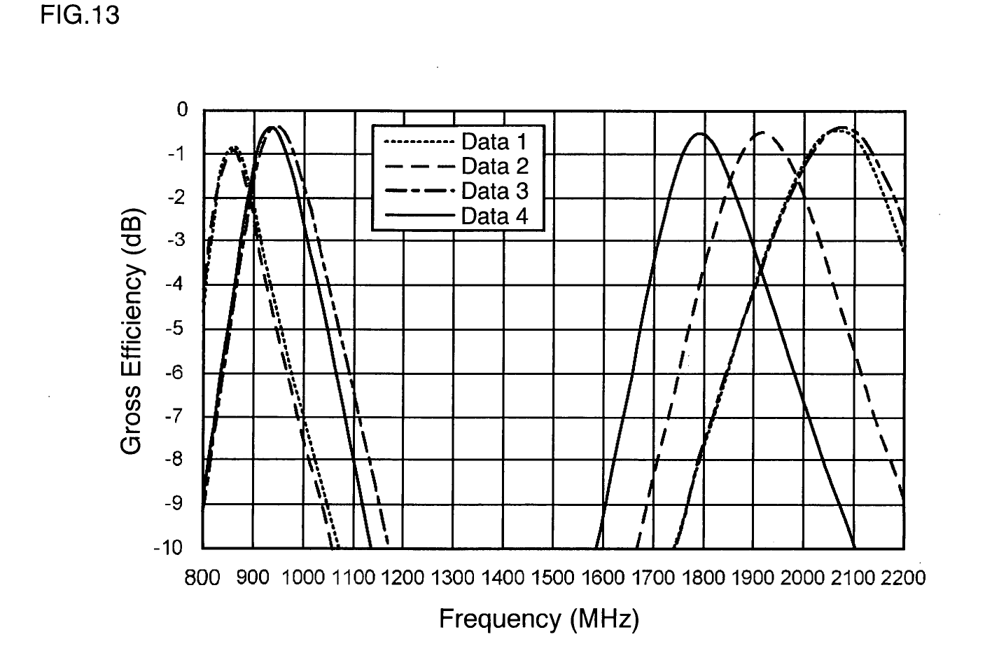

FIG. 13 is a figure showing a frequency performance by a simulation using the antenna device 4. A vertical axis shows gross efficiency [dB] and a horizontal axis shows frequency [MHz]. The efficiency of 0 [dB] means a maximum efficiency using a resonant frequency. NEC-2 is adopted as a simulator.

Simulation parameters of “Data 1” to “Data 4” are described below.

### “Data 1” (Shown Using a Dotted Line)

| | |
|---|---|
| The variable capacitor 14 | Unloaded (Through). |
| The variable inductor 15 | Unloaded (Through). |

### “Data 2” (Shown Using a Dashed Line)

| | |
|---|---|
| The variable capacitor 14 | Unloaded (Through). |
| The variable inductor 15 | The inductance is 5 [nH (nano Henry)]. |

### “Data 3” (Shown Using a Dashed-Dotted Line)

| | |
|---|---|
| The variable capacitor 14 | The capacity is 3 [pF (pico Farad)]. |
| The variable inductor 15 | Unloaded (Through). |

### “Data 4” (Shown Using a Solid Line)

| | |
|---|---|
| The variable capacitor 14 | The capacity is 3 [pF]. |
| The variable inductor 15 | The inductance is 5 [nH]. |

The resonant frequencies of “Data 1” and “Data 2” are almost equal in a low frequency area. This means that the resonant frequency of the antenna device 4 is almost fixed in the low frequency area even if the inductance of the variable inductor 15 varies. On the other hand, the resonant frequencies of “Data 1” and “Data 2” are different in a high frequency area, where the resonant frequency of “Data 1” is approximately 2100 [MHz] and the resonant frequency of “Data 2” is approximately 1900 [MHz]. This means that the resonant frequency of the antenna device 4 varies in the high frequency area with varying the inductance of the variable inductor 15.

The resonant frequencies of “Data 1” and “Data 3” are almost equal in the high frequency area. This means that the resonant frequency of the antenna device 4 is almost fixed in the high frequency area even if the capacity of the variable capacitor 14 varies. On the other hand, the resonant frequencies of “Data 1” and “Data 3” are different in the low frequency area, where the resonant frequency of “Data 1” is approximately 850 [MHz] and the resonant frequency of “Data 3” is approximately 950 [MHz]. This means that the resonant frequency of the antenna device 4 varies in the low frequency area with varying the capacity of the variable capacitor 14.

According to FIG. 13, we can see that the two resonant frequencies vary independently with keeping high efficiency by varying the capacity of the variable capacitor 14 in the low frequency area and by varying the inductance of the variable inductor 15 in the high frequency area.

According to the fourth embodiment, the antenna element of the antenna device 4 has the two folding structures which one is from the feeding point 12 to the variable capacitor 14 and another is from the variable capacitor 14 to the opened end. Therefore, the antenna device 4 realizes smaller size compared with the antenna devices 1 to 3. Moreover, in the antenna device 4, the variable capacitor 14 and the variable inductor 15 are arranged close to each other. Therefore, the variable capacitor 14 and the variable inductor 15 are packed in a module.

### Description of the Fifth Embodiment

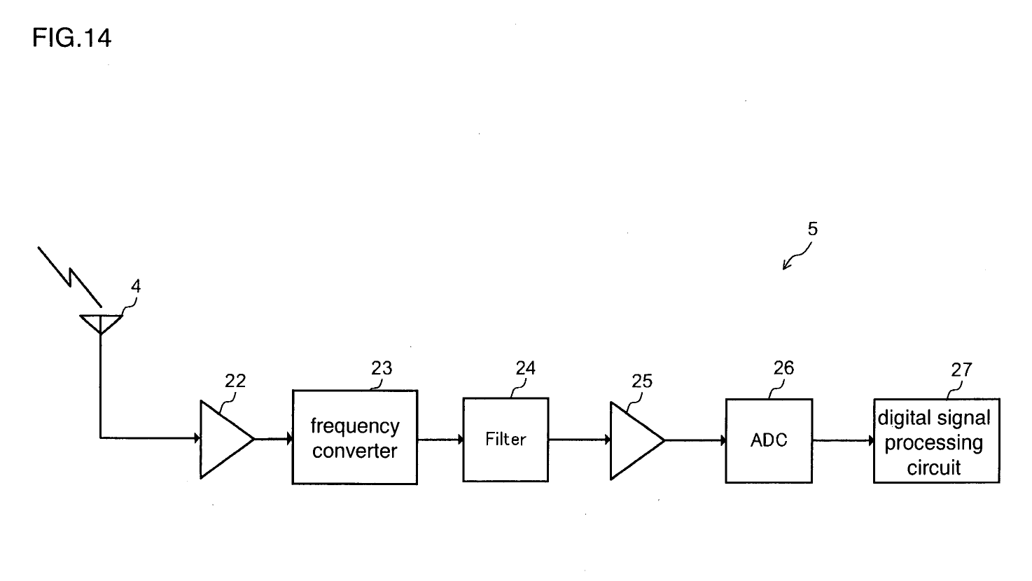

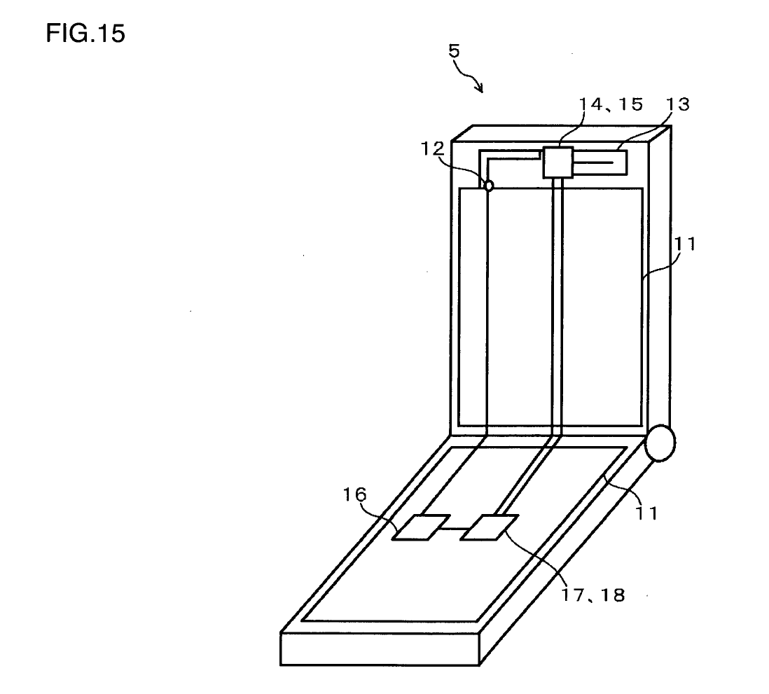

As shown in FIG. 14, the radio apparatus 5 includes an antenna device 4, an amplifier 22, a frequency converter 23, a filter 24, a gain-variable amplifier 25, the A/D converter (ADC) 26 and a digital signal processing circuit 27. Moreover, FIG. 15 shows an example of the radio apparatus 5 using the antenna device 4.

The antenna device 4 receives a radio signal. The amplifier 22 amplifies the radio signal from the antenna device 4. The frequency converter 23 converts the radio signal amplified by the amplifier 22 into an analog baseband signal. The filter 24 allows only a given frequency band of the analog baseband signal from the frequency converter 23 to transmit through the filter 24. This means that the filter 24 removes an interference wave included in the analog baseband signal.

The gain-variable amplifier 25 amplifies the analog baseband signal from the filter 24 and keeps the amplitude of the analog baseband signal to be constant. The A/D converter 26 converts the analog baseband signal from the gain-variable amplifier 25 to a digital baseband signal. The digital signal processing circuit 27 performs baseband signal processing for the digital baseband signal from the A/D converter 26. The baseband signal processing may include sampling rate conversion, noise removal, and demodulation.

As described above, the radio apparatus 5 includes the antenna device 4 of the fourth embodiment to transmit/receive a radio signal. The effects obtained in the fifth embodiments are same as those obtained in the fourth embodiment. The radio apparatus 5 may adopt any one of the antenna devices 1-3 of the first to third embodiment instead of the antenna device 4 of the fourth embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna device, comprising:
an antenna element having a length which is a quarter of a wavelength due to a first frequency, one end of the antenna element being connected to a feeding point, other end of the antenna element being opened;
a capacitor arranged at a position having a distance which is equal or shorter than a half of a wavelength due to a second frequency from the other end of the antenna element; and
an inductor arranged at a position having a distance which is equal or shorter than a quarter of the wavelength due to the second frequency from the other end of the antenna element.

2. The antenna device of claim 1, further comprising:
a capacitor controller varying a capacity of the capacitor; and
an inductor controller varying an inductance of the inductor.

3. The antenna device of claim 1, wherein
the second frequency is higher than the first frequency.

4. The antenna device of claim 1, wherein
the antenna element has an inverted L-shaped or an inverted F-shaped.

5. The antenna device of claim 1, wherein
the antenna element has a folding structure including a first element and a second element,
one end of the first element being connected to the feeding point,
other end of the first element being connected to the capacitor,
one end of the second element being connected to a conductor plate near the feeding point, and
other end of the second element being connected to the first element at a location near the other end of the first element.

6. The antenna device of claim 1, wherein
the first frequency is approximately one-third of the second frequency.

7. The antenna device of claim 1, wherein
the capacitor is formed by MEMS (Micro Electro Mechanical System).

8. A radio apparatus, comprising:
an antenna device including
an antenna element having a length which is a quarter of a wavelength due to a first frequency, one end of the antenna element being connected to a feeding point, other end of the antenna element being opened,
a capacitor arranged at a position having a distance which is equal or shorter than a half of a wavelength due to a second frequency from the other end of the antenna element, and
an inductor arranged at a position having a distance which is equal or shorter than a quarter of the wavelength due to the second frequency from the other end of the antenna element;
a frequency convertor converting a radio signal received by the antenna device into an analog baseband signal;
an A/D convertor converting the analog baseband signal from the frequency convertor to a digital baseband signal; and
a digital signal processing circuit performing baseband signal processing for the digital baseband signal.
